(19) United States
(12) Patent Application Publication
(10) Pub. No.: US 2010/0271167 A1
(43) Pub. Date: Oct. 28, 2010

(54) METHOD FOR MANUFACTURING FUSE BASE AND PRODUCT THEREOF

(76) Inventor: Chun-Chang Yen, Hsichih city (TW)

Correspondence Address: LEONG C LEI, PMB # 1008, 1867 YGNACIO VALLEY ROAD, WALNUT CREEK, CA, 94598, US

(21) Appl. No.: 12/430,911

(22) Filed: Apr. 28, 2009

(51) Int. Cl. H01H 85/20; H01H 69/02

(52) U.S. Cl. 337/186; 29/623

(57) ABSTRACT

Disclosed is a method for manufacturing a base of a fuse, as well as a product of fuse base, which replaces a conventional human based process with a full-machine automatic process including the steps of loading metal wire rolls in racks; cutting the metal wire to a desired length to provide leads; forming a fixing portion on each lead; providing a formed body of the base; fitting and fixing the leads in the body; flattening ends of the leads; and completing a product of the fuse base. The fuse base so manufactured includes a body and two leads. The body forms through holes each having a lower end forming a diverging lead-in opening. Each lead forms a flattened fixing portion and is fit into a respective hole of the body through the lead-in opening with automatic machines and fixed in the fitting hole with the fixing portion.

### (a) TECHNICAL FIELD OF THE INVENTION

The present invention generally relates to novel techniques in respect of manufacturing of a fuse base and a product thereof, which replaces the human labor based processes for manufacturing fuse bases with a full machine-based automatic operation so that the manufacturing of fuse bases is fit for a fully automatic machine-based process.

### (b) DESCRIPTION OF THE PRIOR ART

The type of fuse that is discussed here in the application is generally of a rectangular or circular configuration as shown in FIGS. 1 and 2 of the attached drawings. Also referring to FIG. 3, this type of fuse comprises a base 1, which is comprised of a body 10 and two leads 20 extending through the body 10, and a cover 2. Tips of the two leads 20 extending through the body 10 are flattened to form terminals 22, between which a fusible filament 30 is interposed.

A known process for making the conventional fuse base and a product thereof are respectively illustrated in FIGS. 4-6. Firstly, a roll of metal wire is manually loaded in a supplying rack and the wire is withdrawn from the roll by a predetermined length and then cut to provide two leads 20 of substantially the same length. Each lead 20 is further processed to form a deformed flat section or texture 21 at a location close to a terminal 22 thereof. The two leads 20 are then manually positioned into a mold for making the body 10 to carry out injection molding and thus completing the manufacturing of the base 1. Since the whole manufacturing process of the base 1 relies almost on human labor, especially the leads 20 being manually positioned in the mold, human errors inevitably occur, leading to skewing or non-corresponding lengths of the leads 20. Consequently, flaw or damage products may be of a high percentage. This certainly needs to improve.

### SUMMARY OF THE INVENTION

The present invention aims to provide a method for manufacturing a base of a fuse, as well as a product of fuse base, which replaces a conventional human based process with a full-machine automatic process. As shown in FIGS. 7 and 8, the method comprises the following steps: loading metal wire rolls in racks; cutting the metal wire to a desired length to provide leads; forming a fixing portion on each lead; providing a formed body of the base; fitting and fixing the leads in the base body; flattening ends of the leads; and completing a product of the fuse base. As shown in FIGS. 9 and 10, the product of the fuse base 1 comprises a body 10 and two leads 20. The body 10 has left and right side portions each forming a fitting hole 11 extending through top and bottom faces of the body 10. Each fitting hole 11 has a diverging lead-in opening at the lower end thereof. Each lead 20 is formed with a flattened fixing portion 21 at a location close to a top terminal end of the lead 20. The lead 20 can then be fit into the fitting hole of the base body with the terminal end thereof with automatic mechanical facility, and fixed in the fitting hole by the fixing portion.

Thus, the objective of the present invention is to provide a method for manufacturing a fuse base that replaces a conventional human based process with a full-machine automatic process so as to minimize the potential risk of human error in the conventional process and to enhance the precision of assembling.

The present invention also provides a fuse base comprised of a body, preferably made of insulation material, and two leads, which are electrically conductive, and the base is constructed in such a way that assembling the lead to the body can be done in a human error free and precision enhanced manner.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a conventional rectangular fuse.

FIG. 2 is a perspective view showing a conventional circular fuse.

FIG. 3 is a schematic view showing inside structure of a fuse.

FIG. 4 is a flowchart illustrating a conventional method for manufacturing a fuse base.

FIGS. 5 and 6 show structural details of a base of the conventional fuse device.

FIG. 7 is a flowchart illustrating a method for manufacturing a fuse base in accordance with the present invention.

FIG. 8 is a schematic view demonstrating steps of the method of the present invention for manufacturing the fuse base.

FIG. 9 is an exploded view of a fuse base manufactured in accordance with the present invention.

FIGS. 10 and 11 show structural details of the fuse base of the present invention.

FIG. 12 is a cross-sectional view of the fuse base of the present invention.

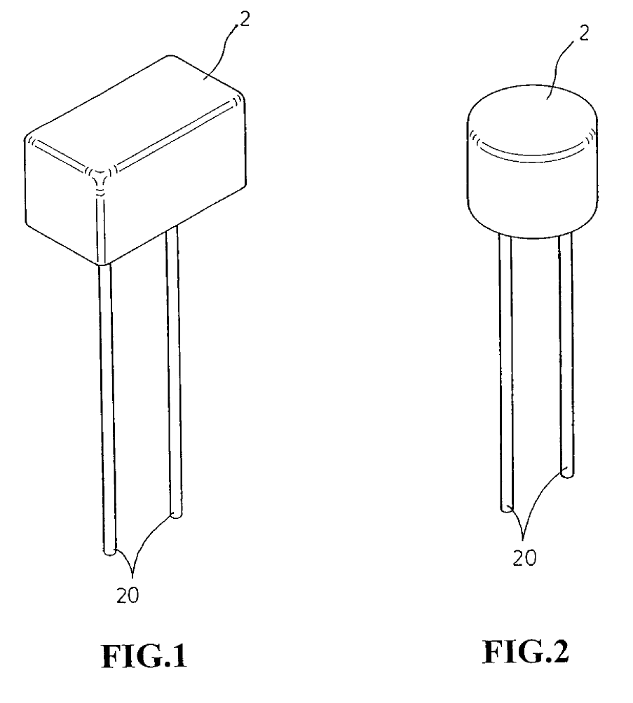

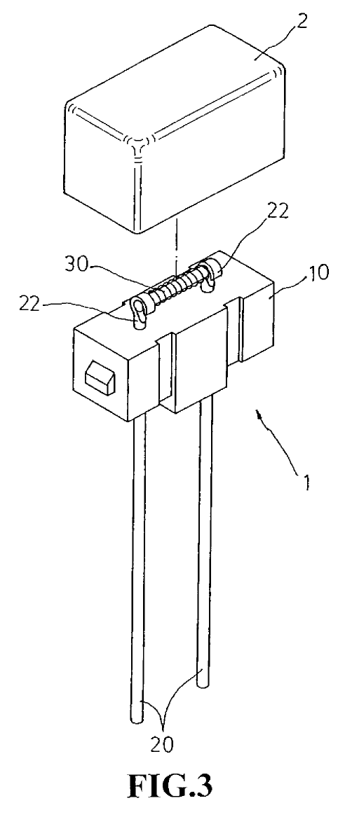

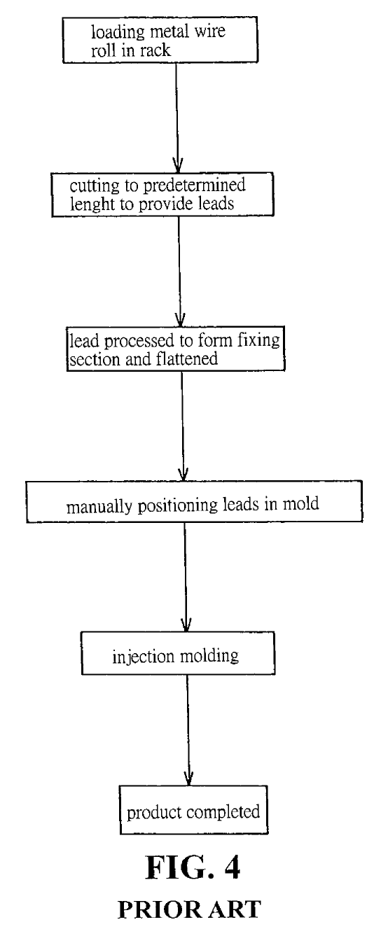

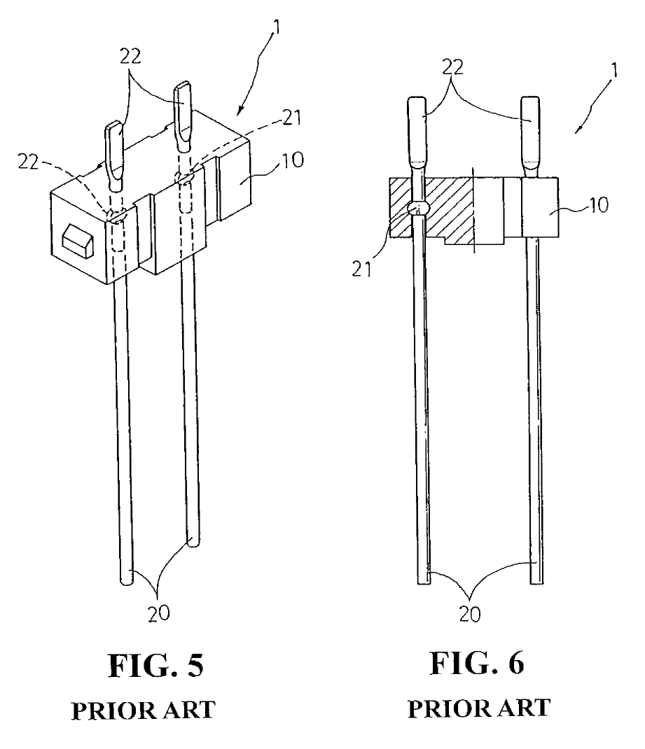

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

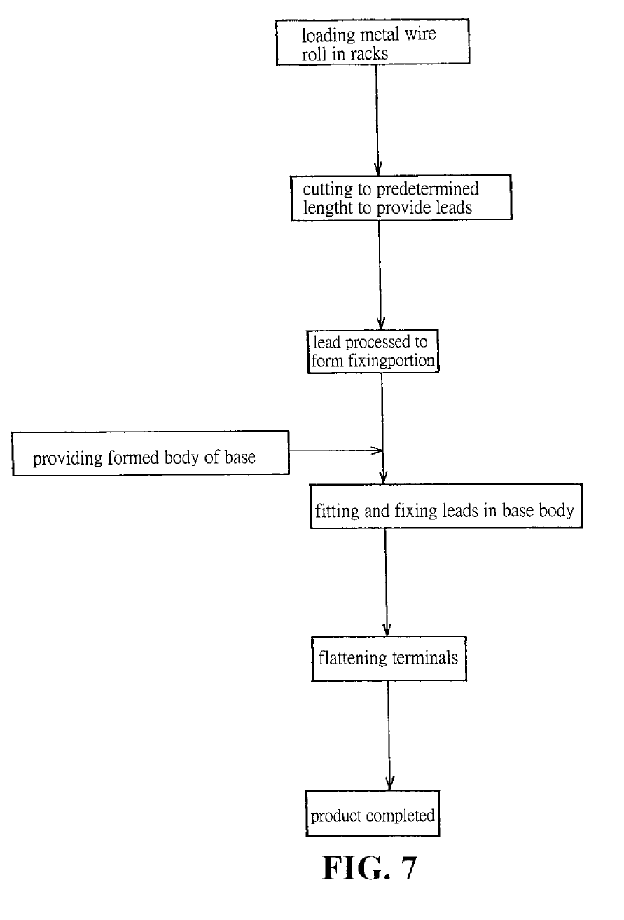

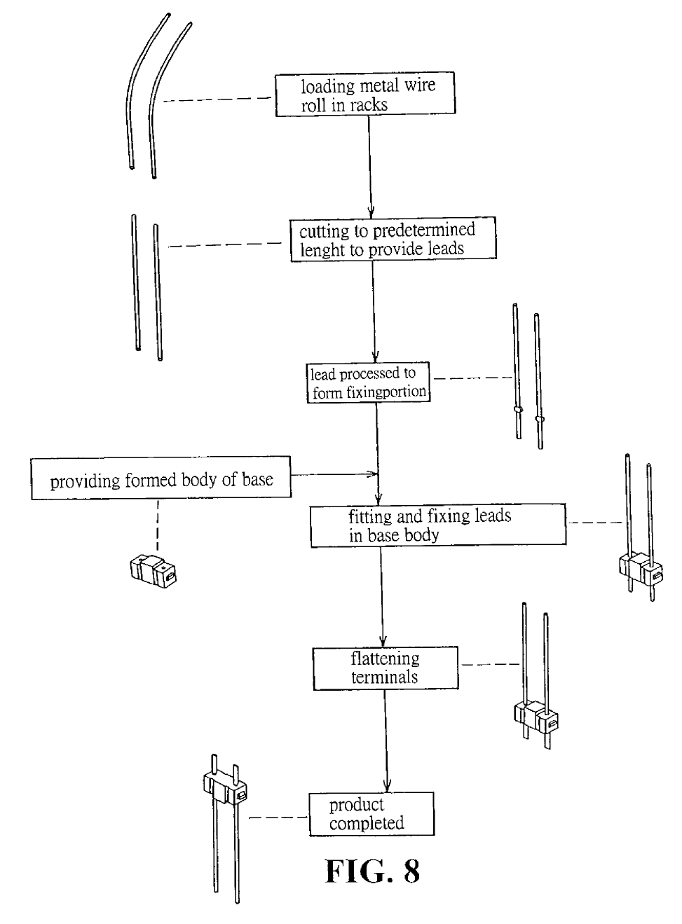

With reference to FIGS. 7 and 8, the present invention provides a method for manufacturing a base of a fuse. The method starts with loading, either manually or in a machine-assisted manner, two rolls of metal wires in left and right supplying racks in a full machine based automatic operation system. Then, the metal wires are withdrawn by machines to a desired length and cut to provide two leads of substantially identical length. The leads are then conveyed and machines are operated to carry out a flattening/texturing operation on each lead at a location close to an end of the lead. The lead is then clamped and moved by machines to an assembling zone where a formed body that constitutes in part the fuse base is transported and fitting and fixing of the two leads in the base body is automatically carried out with machines. Afterwards, the assembly is moved and machines are used to carry out a flattening operation on the terminal of each lead of the assembled base to end the operation of the method.

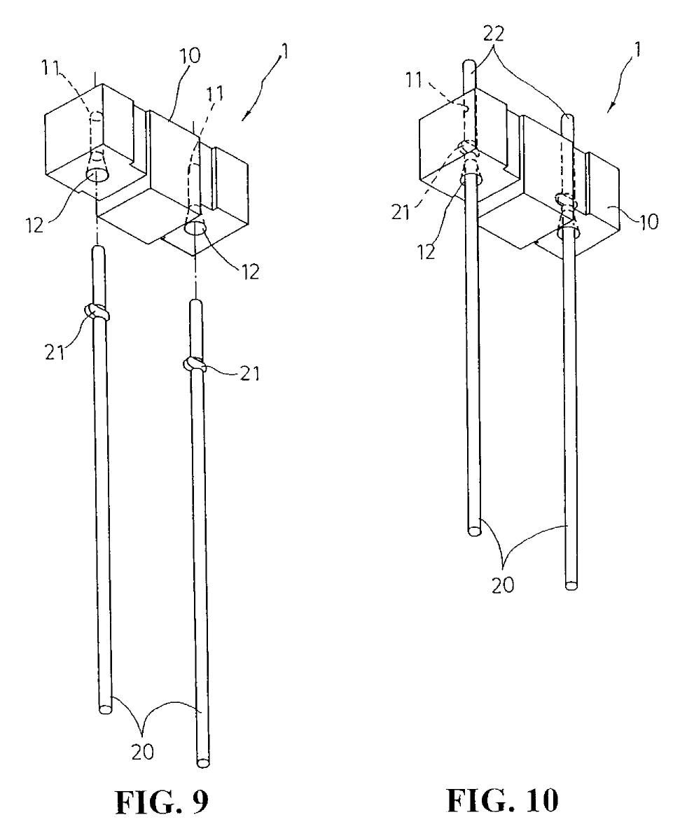

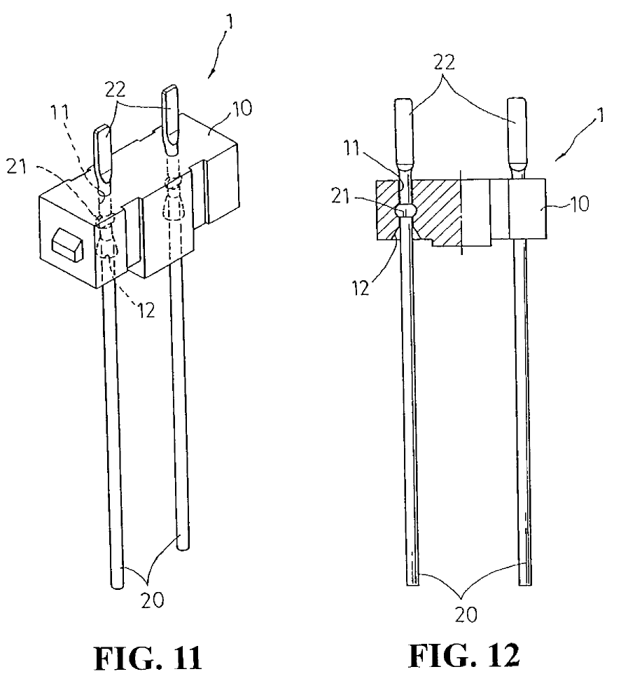

Referring to FIGS. 9-12, a product of the fuse base in accordance with the present invention, generally designated at 1, is comprised of a body 10 and two leads 20. The body 10 has left and right side portions each forming a fitting hole 11 extending through both top and bottom faces of the body 10. The fitting hole 11 has a lower end that forms a diverging lead-in opening 12. Each lead 20 has a top end and each lead 20 forms a flattened fixing portion or texture 21 at a location close to the top end. The lead 20 with this configuration is allowed to fit into the fitting hole 11 of the body 10 through the lead-in opening 12 with automatic machines. The lead 20 is fixed inside the fining hole 11 by the fixing portion or texture 21 engaging the inside wall of the fitting hole and the top end of the lead 20 projects beyond the top face of the fitting hole 11 to serve as a terminal 22 that can then be flattened. The above arrangement can eliminate potential human errors in assembling the body and the leads in the process of manufacturing the fuse base and as a consequence, flaws and damages of the final products can be reduced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for manufacturing a base of a fuse, comprising the following steps: loading metal wire rolls in racks; cutting the metal wire to a desired length to provide leads; forming a fixing portion on each lead; providing a formed body of the base; fitting and fixing the leads in the body of the base; flattening ends of the leads; and completing a product of the fuse base.

2. A fuse base comprising a body and two leads, the body having two side portions each forming a hole extending through top and bottom faces of the body and having a lower end forming a diverging lead-in opening, each lead having a top end and forming a flattened fixing portion, so as to allow the lead to be fit into a respective fitting hole of the body through the lead-in opening with automatic machines and fixed in the fitting hole with the fixing portion.
